(19) United States
(12) Patent Application Publication
(10) Pub. No.: US 2024/0422465 A1
(43) Pub. Date: Dec. 19, 2024

(54) AMPLIFIER MICROPHONE

(71) Applicant: Shure Acquisition Holdings, Inc., Niles, IL (US)

(72) Inventors: John Born, Niles, IL (US); Benjamin Jay Grigg, Chicago, IL (US); Jill Yang, Niles, IL (US)

(21) Appl. No.: 18/739,782

(22) Filed: Jun. 11, 2024

Related U.S. Application Data
(60) Provisional application No. 63/472,744, filed on Jun. 13, 2023.

(51) Int. Cl. H04R 1/02

(52) U.S. Cl. CPC H04R 1/028; H04R 1/021; H04R 2201/025

(57) ABSTRACT

A microphone may comprise a housing and a rotatable positioning member. The rotatable positioning member may be configured to aid in the specific placement of the microphone capsule relative to the surface of an audio output device. The rotatable positioning member may offset a force caused by a tension in a cable connected to the housing based on the rotatable positioning member being rotated from a first position to a second position.

### CROSS-REFERENCE TO RELATED APPLICATION

This application claims priority to U.S. Provisional Patent Application No. 63/472,744, filed on Jun. 13, 2023, which is hereby incorporated by reference in its entirety.

### FIELD

Aspects described herein generally relate to an amplifier microphone. More specifically, one or more aspects described herein provide for an amplifier microphone adapted to account for tension in a microphone cable and configured for specific placement of the microphone capsule.

### BACKGROUND

Microphones may be hung on a guitar amplifier and may thus eliminate the need for a mic stand. The sound quality, tone, timbre, etc. of the captured sound may vary drastically as a function of where a microphone capsule is located relative to a loudspeaker element, the angle at which it is oriented, etc. Microphone cables may contain built-up tension (i.e., memory) that may cause the microphone capsule to rotate away from a desired orientation to and/or position of the capsule relative to the loudspeaker, which may negatively affect sound quality.

### SUMMARY

The following presents a simplified summary of the disclosure in order to provide a basic understanding of some aspects of the disclosure. This summary is not an extensive overview of the disclosure. It is not intended to identify key or critical elements of the invention or to delineate the scope of the invention. The following summary merely presents some concepts of the disclosure in a simplified form as a prelude to the more detailed description provided below.

Musicians and sound engineers often hang a microphone on an amplifier to capture the sound emanating from the speaker element(s). Certain microphones, such as direct-address microphones, may have microphone capsules that are pointed toward the floor instead of the amplifier when hung from the amplifier. Side-address microphones may be prone to rolling away from a desired position and/or orientation relative to the amplifier due to memory and/or built-up tension in the connected cable.

As described in more detail herein, this application sets forth apparatuses for quick and reliable placement of a microphone against, for example, the grille of an amplifier, the face of a speaker enclosure, and/or any surface of audio equipment irrespective of how tension in a connected cable may affect the positioning of the microphone. The microphone may be rotated at any number of desired angles relative to the surface of the amplifier/speaker to achieve a desired sound quality.

An example microphone may comprise a microphone capsule and a rotatable positioning member for biasing the microphone capsule against a surface of an audio output device. The rotatable positioning member may be configured to offset a force caused by a tension in a cable connected to the microphone based on the rotatable positioning member being rotated from a first position to a second position.

An example microphone may comprise a housing configured to connect to a cable and a rotatable positioning member integral to the housing configured to orient a microphone capsule relative to a surface of an audio output device. The rotatable positioning member may be configured to maintain an electrical connection between the housing and the cable based on the positioning member being rotated from a first position to a second position

These as well as other novel advantages, details, examples, features and objects of the present disclosure will be apparent to those skilled in the art from following the detailed description, the attached claims and accompanying drawings, listed herein, which are useful in explaining the concepts discussed herein.

### BRIEF DESCRIPTION OF THE DRAWINGS

Some features are shown by way of example, and not by limitation, in the accompanying drawings. In the drawings, like numerals reference similar elements.

FIG. 1 illustrates an example network architecture that may be used to implement one or more illustrative aspects described herein.

FIG. 2a illustrates an example arrangement of an example microphone that may be used to implement one or more illustrative aspects described herein and an amplifier unit.

FIG. 2b illustrates another example arrangement of an example microphone that may be used to implement one or more illustrative aspects described herein and an amplifier unit.

FIG. 3 illustrates a front view of an example amplifier microphone that may be used to implement one or more illustrative aspects described herein.

FIG. 4a illustrates a side view of the example amplifier microphone of FIG. 3.

FIG. 4b illustrates a partial cross-section view of an example amplifier microphone as indicated by the line “FIG. 4b” in FIG. 4a.

FIG. 4c illustrates a partial cross-section view of an example amplifier microphone as indicated by the line “FIG. 4c” in FIG. 4a.

FIG. 5 illustrates a front view of an example amplifier microphone that may be used to implement one or more illustrative aspects described herein.

FIG. 6 illustrates a partial exploded view of the example amplifier microphone of FIG. 5.

### DETAILED DESCRIPTION

In the following description of the various examples, reference is made to the accompanying drawings, which form a part hereof, and in which is shown by way of illustration various examples in which aspects may be practiced. References to “embodiment,” “example,” and the like indicate that the embodiment(s) or example(s) of the invention so described may include particular features, structures, or characteristics, but not every embodiment or example necessarily includes the particular features, structures, or characteristics. Further, it is contemplated that certain embodiments or examples may have some, all, or none of the features described for other examples. And it is to be understood that other embodiments and examples may be utilized and structural and functional modifications may be made without departing from the scope of the present disclosure.

Unless otherwise specified, the use of the serial adjectives, such as, “first,” “second,” “third,” and the like that are used to describe components, are used only to indicate different components, which can be similar components. But the use of such serial adjectives is not intended to imply that the components must be provided in given order, either temporally, spatially, in ranking, or in any other way.

Also, while the terms “front,” “back,” “side,” and the like may be used in this specification to describe various example features and elements, these terms are used herein as a matter of convenience, for example, based on the example orientations shown in the figures and/or the orientations in typical use. Nothing in this specification should be construed as requiring a specific three dimensional or spatial orientation of structures in order to fall within the scope of the claims.

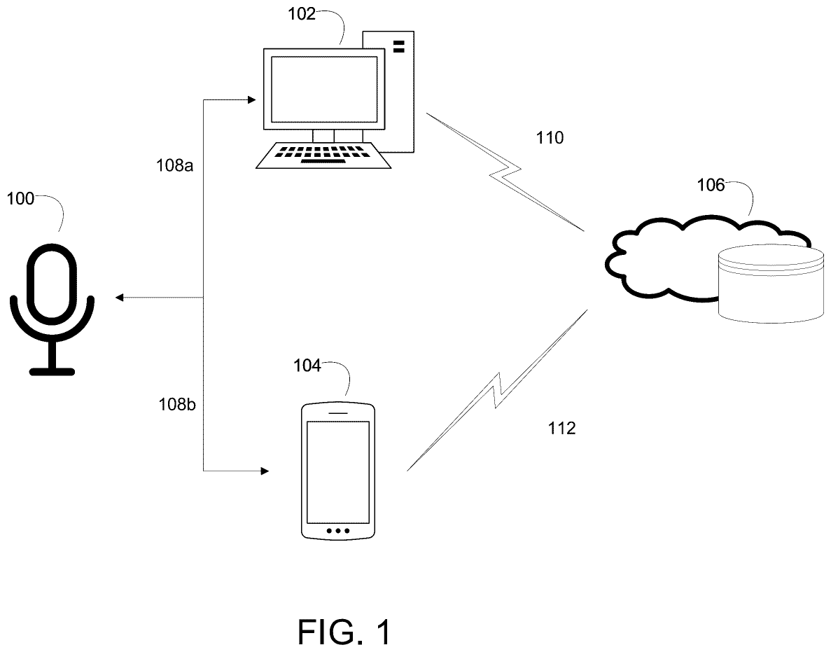

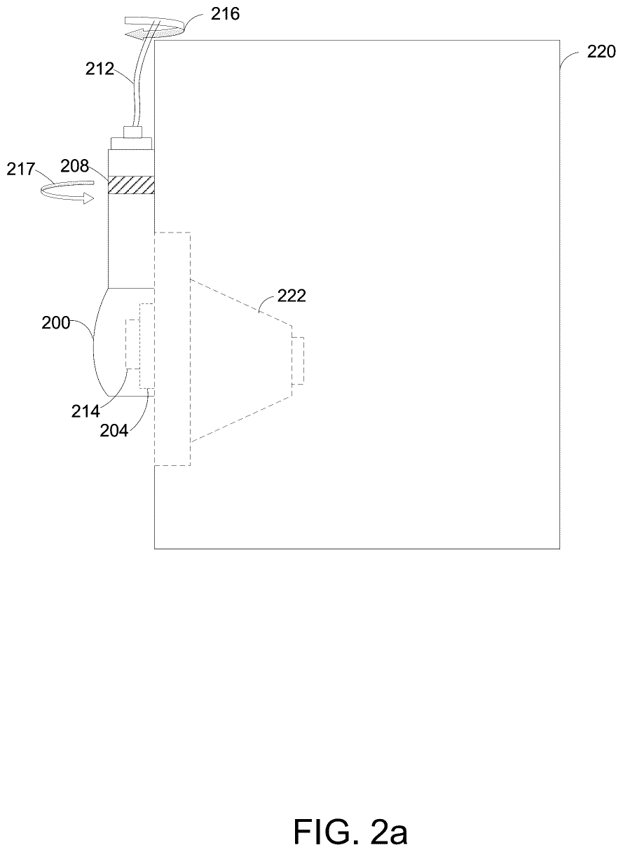

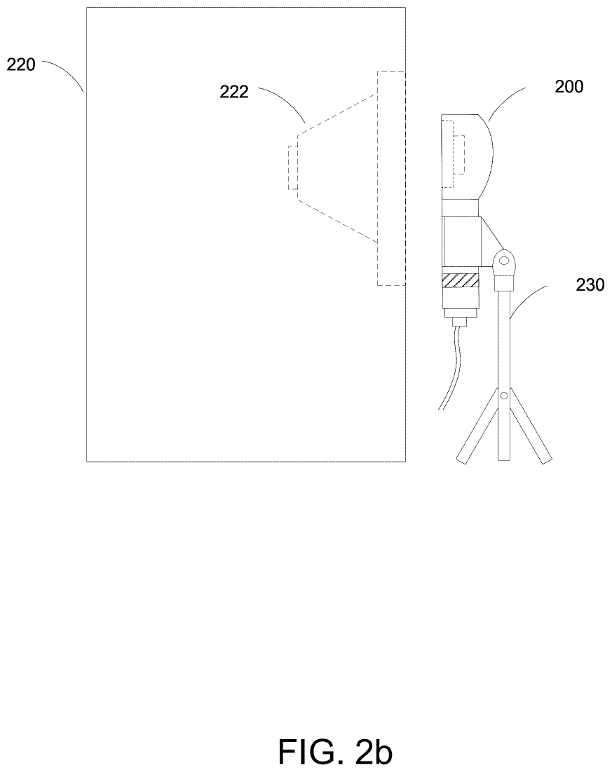

FIG. 1 illustrates an example of a network architecture that may be used to implement one or more illustrative aspects described herein in a standalone and/or networked environment. Device 100 may be a microphone. Device 100 may be connected to and/or in communication with devices 102 and 104. Device 102 may be a desktop or laptop computer. Device 104 may be a smartphone or tablet. Devices 102 and/or 104 may be a mixing console, a recording console, a stage box, a direct box (i.e., a “Direct Inject” (“DI”) box), any type of audio interface, and the like. Any one or more of devices 100, 102, 104, and 106 may be any type of known computer or server. In some examples, devices 102 and 104 may include a user interface, including a graphical user interface, to allow a user to interact with the system. In one example, device 106 may be a data server, including a cloud-based data server. Devices 100, 102, 104, and 106 may be interconnected via wide area network (WAN), such as the Internet. Other networks may also or alternatively be used, including local area networks (LAN), wireless networks, personal networks (PAN), and the like. Devices 100, 102, 104, and 106 and other devices (not shown) may or might not be communicatively connected to one or more of the networks via twisted pair wires, coaxial cable, fiber optics, radio waves, or other communication media. In some examples, device 100 may be communicatively connected to device 102 and/or device 104 via connections 108a and/or 108b, respectively. Device 102 and/or device 104 may connect to device 100 via connections 108a and/or 108b using any one of a variety of different connectors, including, for example, cable 212 (FIG. 2). Cable 212 may include a LEMO connector, an XLR connector, a Lightning® connector, a TQG connector, a TRS connector, a USB connector (including, but not limited to, USB type A, type B, type C, Mini B, Micro B) or RCA connectors, etc. Device 102 may be communicatively connected to device 106 via connection 110 and device 104 may be communicatively connected to device 106 via connection 112.

Microphone 200 may be configured in a number of ways to capture sound from a loudspeaker, such as a guitar amplifier and/or any other audio output device, etc. Microphone 200 may be configured to capture sound from any number of stringed instruments, such as a piano, a guitar, a violin, etc., any number of brass instruments, and/or any number of single-reed or double-reed woodwind instruments. FIG. 2a illustrates an example arrangement of microphone 200 and amplifier unit 220. Microphone 200 may be hung from the top of amplifier unit 220 and/or placed in front of speaker element 222 such that microphone capsule 214 captures sound from speaker element 222. Microphone 200 may be placed in a number of positions on the front surface of amplifier unit 220 (i.e., the surface from which sound exits speaker element 222) depending on user preferences. Cable 212 may be connected to microphone 200. Cable 212 may have built-up tension that may impart a rotative force 216 on microphone 200 causing sound inlet 204 and/or microphone capsule 214 to rotate away from the front face (or surface) of speaker element 222. Microphone 200 may include rotatable positioning member 208. Rotatable positioning member 208 may be manipulated by force 217 to correctively bias sound inlet 204 and microphone capsule 214 to account for the rotative force 216 caused by built-up tension in cable 212. Based on manipulation of rotatable positioning member 208, microphone capsule 214 of microphone 200 may be repositioned so that it is substantially flush with the front face, or surface, of speaker element 222. Based on manipulation of rotatable positioning member 208, microphone capsule 214 may be repositioned so that it is substantially parallel with the speaker element 222. Microphone 200 and microphone capsule 204 may be positioned at a number of locations and/or orientations with respect to speaker element 222 based on manipulation of rotatable positioning member 208. Microphone 200 and microphone capsule 204 may be positioned at a number of locations and/or orientations with respect to any number of speaker elements (i.e., one or more of speaker elements 222) based on manipulation of rotatable positioning member 208.

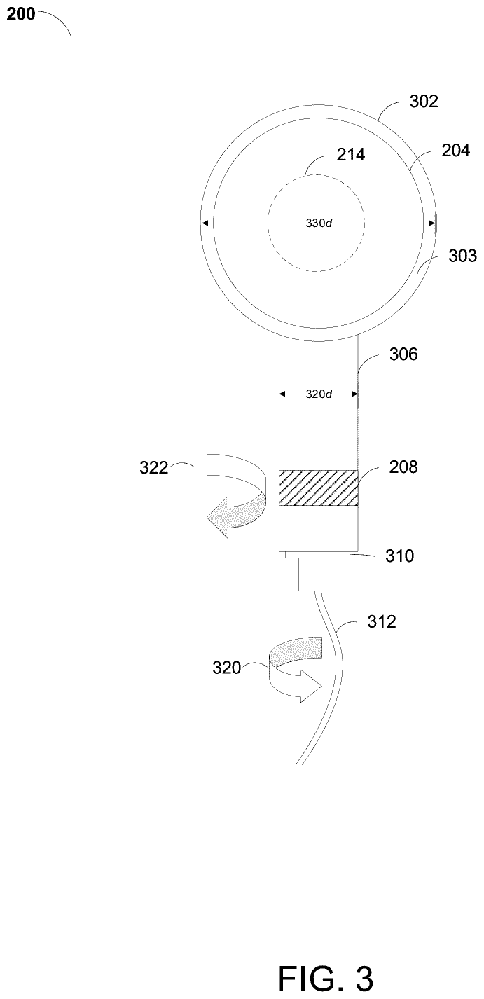

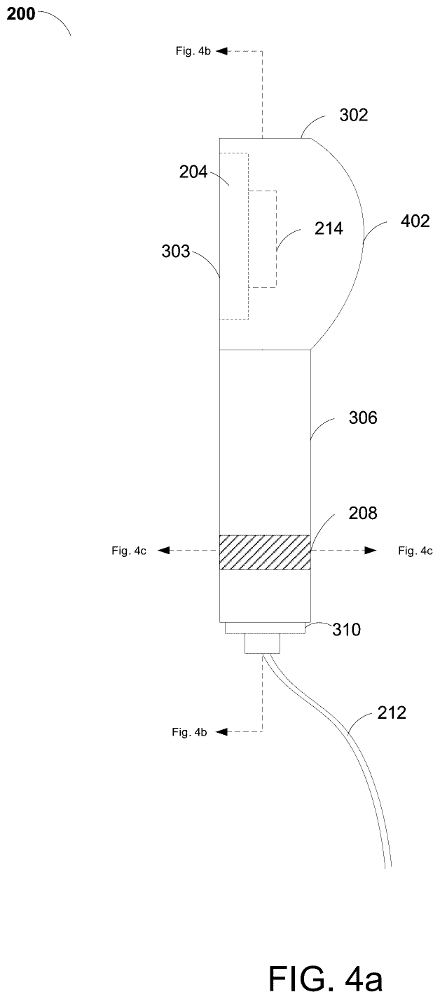

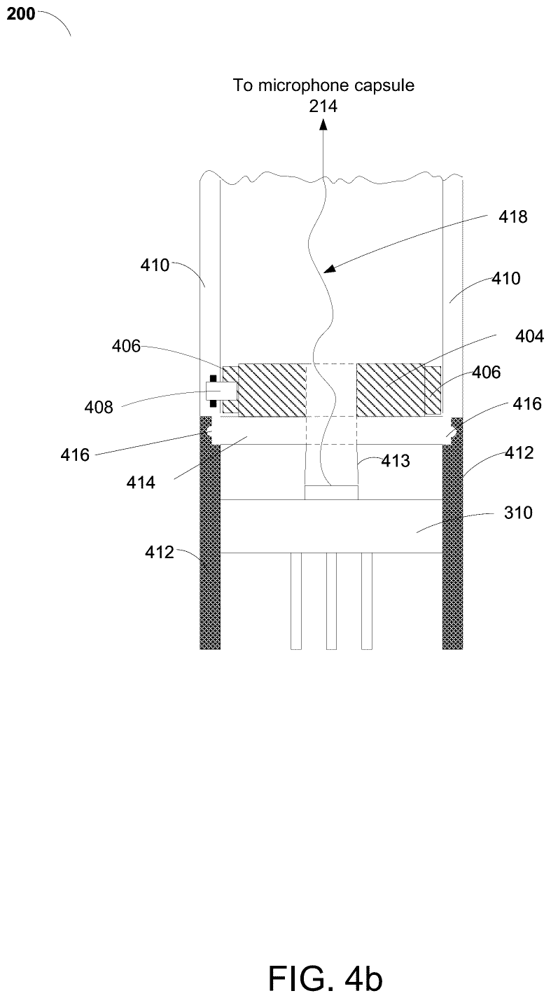

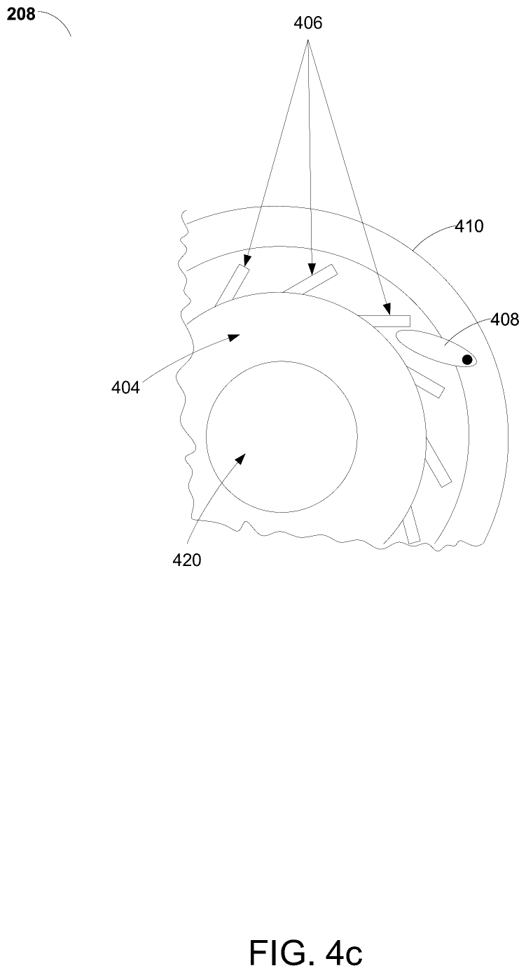

Referring to FIG. 2b, microphone 200 may be compatible with any number of types of stand, such as stand 230. Microphone 200 may interface with stand 230 and may be removably coupled to stand 230. Stand 230 may be adjusted for precise positioning of microphone 200 relative to speaker element 222 of amplifier unit 220. Stand 230 may be integral to microphone 200. For example, stand 230 may be integral to member 306 (FIG. 3), housing 302 (FIG. 3), back side 402 (FIG. 4a), etc. Stand 230 may be adapted to removably couple to any number of instruments. Stand 230 may be configured to rotate vertically and/or horizontally such that microphone capsule 214 may be oriented at a number of different angles relative to speaker element 222 (i.e., substantially parallel to speaker element, placed at any number of positions with respect to speaker element 222 (i.e., away from the center of speaker element 222, in the center of speaker element 222, etc.) and/or placed at any number of distances to speaker element 222 (i.e., flush to a front surface of speaker element 222 or at a distance away from the front surface of speaker element 222, etc.).

Referring to FIG. 3, microphone 200 may include a housing 302. Housing 302 may include some or all of the components described herein. Housing 302 may include a sound inlet 204 and a microphone capsule 214. Sound inlet 204 may include a vent or a port configured to direct acoustic energy toward a microphone capsule 214. Sound inlet 204 may define a volume in which capsule 214 is disposed. Sound inlet 204 may include a grille constructed with any number of types of mesh, such as metal mesh, acoustic mesh, etc. Sound inlet 214 may be substantially flush with a front face 303 of housing 302. Microphone capsule 214 may be any number of capsule types, such as a condenser microphone capsule (e.g., including large- and small-diaphragm and electret condenser), a dynamic microphone capsule (e.g., including moving coil and ribbon microphones), and/or a MEMS microphone capsule, among others. Microphone capsule 214 may have any number of polar patterns, such as cardioid, supercardioid, hypercardioid, omnidirectional, figure-8, etc. Housing 302 may include other electrical components, such as one or more processors, one or more amplifiers, one or more analog-to-digital converters (A/D converter), one or more digital-to-analog converters (D/A converter), a hardware DSP chip, a microcontroller, etc.

Housing 302 may include a connector 310. Connector 310 may be electrically connected to microphone capsule 214 and/or other electrical components discussed herein. Connector 310 may be any number of connector types, such as a LEMO connector, an XLR connector, a Lightning® connector, a TQG connector, a TRS connector, a USB connector (including, but not limited to, USB type A, type B, type C, Mini B, Micro B) or RCA connectors. Connector 310 may connect to cable 212 for providing an audio signal captured by microphone 200 to any number of external devices, including devices 102, 104, and/or other devices such as a recording console, mixing console, etc. As has been discussed, cable 212 may have built-up tension that may cause rotative force 320 to be transferred to microphone 200 when cable 212 is connected to connector 310.

Microphone 200 may include an elongated member 306 (hereinafter referred to as “member 306”). Member 306 may be configured as a handle and may be constructed with any number of geometries, including ergonomic geometries for handheld use, and/or any number of irregular geometries. Member 306 may be substantially elongated or columnar. Member 306 may be integral to housing 302. Connector 310 may be integral to member 306. Connector 310 may be recessed inside member 306.

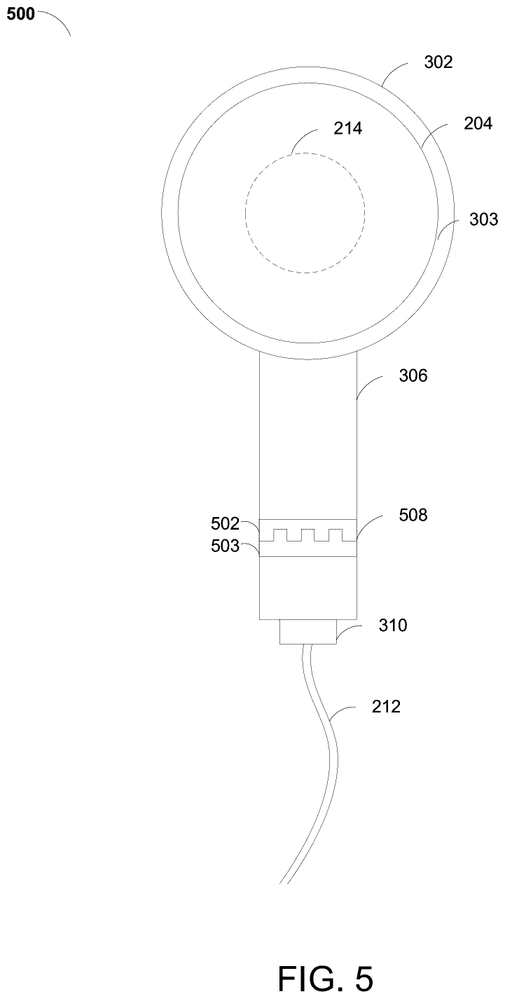

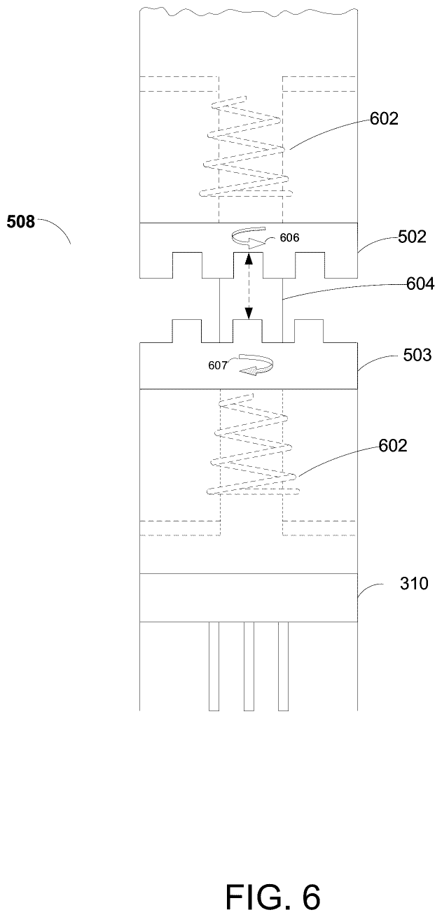

Member 306 and/or housing 302 may include a rotatable positioning member 208 (hereinafter referred to as “positioning member 208”). Positioning member 208 may be integrally disposed along member 306 or housing 302, such as nearer connector 310 or nearer microphone capsule 214. Positioning member 208 may be configured to allow some or all of housing 302 to rotate independently of connector 310 and/or cable 212. Positioning member 208 may be generally manipulated to correctively bias or offset microphone 200 in a direction opposite the rotative force 322 transferred from cable 212 to some or all of microphone 200. For example, a user may apply a rotative force to positioning member 208, which, as a result, may cause microphone capsule 214, sound inlet 204, and a portion of housing 302 nearer microphone capsule 214 to rotate independently of connector 310, cable 212, and/or a portion of member 306 closer to connector 310. Positioning member 208 may comprise a ratchet-style assembly (discussed further with respect to FIGS. 4b and 4c). Positioning member 208 may comprise a spring-plunger type assembly (discussed further with respect to FIGS. 5 and 6). Positioning member 208 may be configured to allow microphone capsule 214 to maintain electrical contact with connector 310 and/or any other electrical components housed in microphone 200 while positioning member 208 is manipulated from a first position to a second position through any number of intermediate positions.

Housing 302 may be configured according to any number of geometries, including irregular geometries. For example, housing 302 may be configured with dimensions 320d and 330d. Dimensions 320d and 330d may be the same. Dimensions 320d and 330d may be different. Dimension 330d may correspond to the greatest width, or diameter, as the case may be, of the first end of microphone housing 302. Dimension 320d may correspond to the smallest width, or diameter, as the case may be, of a second end of housing 302. Dimension 230d may be greater than dimension 320d. Dimension 330d may correspond to the width, or diameter, as the case may be, of face 303 of housing 302. Face 303 may be configured with a width 330d to help provide increased surface area to the portion of housing 302 comprising the sound inlet 204 and microphone capsule 214. The increased surface area may help provide increased stability to sound inlet 204 and capsule 214 when placed flush in front of a loudspeaker. The increased surface area may help provide resistance to built-up tension and other forces in cable 212 that may cause microphone capsule 214 to deviate from an intended location and/or orientation relative to the loudspeaker element 222 of amplifier unit 220. Face 303 and positioning member 208 may function in concert to help offset a force caused by built-up tension in cable 212 connected to the housing 302.

FIG. 4a illustrates a side view of an example amplifier microphone 200 that may be used to implement one or more aspects described herein. Housing 302 may include a front face 303 and a back side 402. Front face 303 may be substantially flat. That is, front face 303 may be configured to interface with a front surface of an amplifier unit, such as a guitar amplifier, without causing the microphone 200 to be biased relative to the front surface of the amplifier unit (as shown in FIG. 2a). Back side 402 may be constructed according to a number of geometries, such as rectangular, arcuate, etc. Back side 402 may be substantially flat.

FIG. 4b illustrates a cross section of microphone 200 as indicated by line “FIG. 3b” in FIG. 3a. As has been discussed herein, positioning member 208 may be configured as a ratchet-style assembly. Positioning member 208 may include a gear 404. Sidewalls 410 and 412 of member 306 may be integrally molded and/or coupled at joints 416. Gear 404 may be fixedly coupled to a plate 414. Plate 414 may be integral to sidewalls 410 or sidewalls 412. In one or more examples, gear 404 may be coupled to hollow shaft 413. Shaft 413 may be coupled to connector 310. A user may apply a rotative force to sidewalls 410 and/or sidewalls 412 to rotate the housing 302 relative to connector 310.

Gear 404 may include radially oriented teeth 406 integrally coupled, molded, etc. to gear 404. Gear 404 may include any number of teeth 406. Teeth 406 may be constructed according to any number of geometries, such as rectangular, triangular, arcuate, etc. Teeth 406 may be evenly distributed around the entire circumference of gear 404. Teeth 406 might not be distributed around the entire circumference of gear 404. Gear 404 may be restricted to rotate a predetermined number of degrees based on the number and location of teeth 406. Teeth 406 may be restricted to one quadrant of gear 404. Teeth 406 may be distributed in one or more quadrants of gear 404. Gear 404 may be restricted to rotate from zero degrees (i.e., a first position) to 90 degrees (i.e., a second position) based on the number of teeth 406. Gear 406 may rotate through any number of intermediate positions based on the number of teeth 406. Positioning member 208 may include a pawl 408 configured to engage the gear teeth 406 as the gear is rotated from a first position, through any number of intermediate positions, to a second position. Pawl 408 may fixedly retain gear 404 in any number of intermediate positions until a sufficient force causes the gear to overcome the restrictive force from pawl 408 and rotate to the next position. Pawl 408 may be switched to allow gear 408 to rotate clockwise and/or counterclockwise (i.e., bidirectionally). Gear 404 and pawl 408 may be configured to permit any number of ranges of rotation of the portion of housing 302 comprising microphone capsule 214 relative to connector 310. For example, gear 404 and pawl 408 may be configured to allow housing 302 to rotate bidirectionally between 0 degrees and 90 degrees. Gear 404 and pawl 408 may be configured to allow housing 302 to rotate bidirectionally between 0 degrees and more or less than 90 degrees (e.g., 45 degrees, 75 degrees, 120 degrees, 135 degrees, 180 degrees, 270 degrees, and/or any other range of rotation). Gear 404 and pawl 408 may be configured to allow unidirectional and/or bidirectional 360-degree rotation of housing 302. Positioning member 208 may include one or more gears 404 with varying number of teeth 406 to achieve both coarse- and fine-control of positioning of microphone capsule 214 relative to connector 310.

Microphone 200 may include one or more electrical wires 418. Wires 418 may be electrically connected to connector 310, microphone capsule 214, and/or any other electrical components described herein. Gear 404 may include a through-hole 420 (FIG. 4c) configured to allow one or more electrical wires 418 passage from microphone capsule 204 to connector 310. Electrical wires 418 may be constructed with any number of conductive materials, such as copper wire, coaxial cable, ribbon cable, flex strip, etc. Wires 418 may include sufficient slack to remain connected to the connector 310 and microphone capsule 214 as positioning member 208 is rotated from a first position to a second position through any number of intermediate positions.

FIG. 4c illustrates a cross section of microphone 200 as indicated by line “FIG. 4c” in FIG. 4a. As has been discussed, gear 404 may include radial teeth 406, pawl 408, and through-hole 420. Through-hole 420 may be threaded to receive hollow shaft 413, which may also be threaded with complementary threads to engage with through-hole 420. Teeth 406 and pawl 408 may work in concert to securely fix housing 302 and/or microphone capsule 214 in a desired orientation relative to connector 310 and/or cable 212. The number of teeth 406 may dictate the number of intermediate positions of housing 302 and/or capsule 214 relative to connector 310 and/or cable 212. The number and distribution of teeth 406 may dictate the range of rotation of housing 302 and/or microphone capsule 214 with respect to connector 310 and/or cable 212.

FIG. 5 illustrates an example microphone 500 that may be used to implement one or more aspects described herein. Microphone 500 may include some or all of the same elements as have been described with respect to microphone 200 herein. Microphone 500 may include a rotatable positioning member 508. Positioning member 508 may be configured as a plunger-style fastener. Positioning member 508 may include fasteners 502 and 503. Fasteners 502 and 503 may include interlocking teeth. Fasteners 502 and 503 may include any number of interlocking teeth. A higher number of interlocking teeth may provide finer position adjustment (i.e., more intermediate positions between a first and second position).

Referring to FIG. 6, fasteners 502 and 503 may be mounted on shaft 604. Shaft 604 may be hollow such that it may provide passage of electrical wires so that microphone capsule 214 and connector 310 remain electrically connected as positioning member 208 is manipulated from a first position to a second position through any number of intermediate positions. Springs 602 may be disposed along shaft 604 below fastener 503 and above fastener 502. Springs 602 may apply a force on fasteners 502 and 503 to keep fasteners 502 and 503 interlocked while microphone 500 is in use. A user may apply an opposing force to springs 602 along a vertical axis defined by shaft 604 to release fasteners 502 and 503. A user may apply rotative forces about the vertical axis of shaft 604 to fastener 503 in one direction (indicated by arrow 607) and to fastener 502 in another direction (indicated by arrow 606) to change the position of a bottom portion of member 306 relative to microphone capsule 214 and/or the position of microphone capsule 214 relative to connector 310.

These and other mechanisms may be used to implement one or more illustrative aspects described herein. For example, positioning members 208 and/or 508 may comprise a plurality of ball bearings and an inner body. The inner body may be integrally coupled to sidewalls 410 or 412. The plurality of ball bearings and the inner body may be adapted to allow the microphone capsule 214 to rotate independently of the connector 310 and/or member 306. Positioning members 208 and/or 508 may comprise a threaded collar. The second end of member 306 nearest connector 310 may comprise complementary threads adapted to receive and removably couple to the threaded collar. In operation, a user may loosen the threated collar, rotate microphone 200 and/or connector 310 to a desired orientation and/or to alleviate built-up tension from cable 212, and securely fashion threaded collar to member 306.

A microphone may comprise a microphone capsule. The microphone may comprise a rotatable positioning member configured to bias the microphone capsule against a surface of an audio output device. The rotatable positioning member may be configured to offset a force caused by a tension in a cable connected to the housing based on the rotatable positioning member being rotated from a first position to a second position. The amplifier microphone may comprise a housing. The housing may further comprise, on a first end of the housing, a substantially flat face, and, on a second end of the housing opposite the first end, a connector for connection of the cable to the housing. The rotatable positioning member may be disposed in the housing intermediate the first end and the second end. The substantially flat face may rotate independently of the connector. The second end of the housing may rotate independently from the first end of the housing. A first diameter of the housing may be greater than a second width of the housing. The second end of the housing may further comprise a recessed portion configured to receive a microphone stand clip. The rotatable positioning member may be configured to securely orient the microphone capsule in a plurality of intermediate positions between the first position and the second position. The positioning member may be integral to the housing. The positioning member may comprise a ratcheting assembly. The positioning member may comprise a plurality of ball bearings and an inner body, wherein the plurality of ball bearings and the inner body are adapted to allow the sound inlet to rotate independently of the connector. The positioning member may comprise a threaded collar and the second end of the housing may comprise complementary threads adapted to receive and removably couple to the threaded collar. The positioning member may comprise a spring plunger assembly. The amplifier microphone may comprise a microphone stand integrally coupled to the housing.

A microphone may comprise a housing configured to connect to a cable. The amplifier microphone may comprise a rotatable positioning member. The rotatable positioning member may be configured to orient a microphone capsule relative to a front surface of an audio output device. The rotatable positioning member may be configured to maintain an electrical connection between the housing and a cable connected to the housing based on the positioning member being rotated from a first position to a second position. The rotatable positioning member may be configured to securely orient the sound inlet in a plurality of intermediate positions between the first position and the second position. The housing may comprise a first end and a second end opposite the first end, wherein a first dimension of the first end of the housing is greater than a second dimension of the second end of the housing. The positioning member may comprise a ratcheting assembly. The housing may further comprise a recessed portion configured to receive a microphone stand clip. The amplifier microphone may comprise a microphone stand integrally coupled to the housing. The positioning member may comprise a plurality of ball bearings and an inner body, wherein the plurality of ball bearings and the inner body are adapted to allow the sound inlet to rotate independently of the connector. The positioning member may comprise a threaded collar and the second end of the housing may comprise complementary threads adapted to receive and removably couple to the threaded collar. The positioning member may comprise a spring plunger assembly.

A microphone may comprise a microphone capsule. The microphone may comprise a housing configured for connection to a cable. The housing may comprise a rotatable positioning member configured to bias a microphone capsule against a surface of an audio output device the microphone may comprise a substantially flat face. The rotatable positioning member and substantially flat face may be configured to function in concert to offset a force caused by a tension in a cable connected to the housing based on the rotatable positioning member being rotated from a first position to a second position.

In the foregoing specification, the present disclosure has been described with reference to specific exemplary examples thereof. Although the invention has been described in terms of a preferred example, those skilled in the art will recognize that various modifications, examples or variations of the invention can be practiced within the spirit and scope of the invention as set forth in the appended claims. The specification and drawings are, therefore, to be regarded in an illustrated rather than restrictive sense. Accordingly, it is not intended that the invention be limited except as may be necessary in view of the appended claims.

1. A microphone comprising:
a microphone capsule; and
a rotatable positioning member configured to bias the microphone capsule against a surface of an audio output device;
wherein the rotatable positioning member is configured to offset a force caused by a tension in a cable connected to the microphone based on the rotatable positioning member being rotated from a first position to a second position.

2. The microphone of claim 1 wherein the microphone further comprises a housing, the housing further comprising:
on a first end of the housing, a substantially flat face; and
on a second end of the housing opposite the first end, a connector for connection of the cable to the housing.

3. The microphone of claim 2, wherein the rotatable positioning member is configured to allow the substantially flat face to rotate independently of the connector.

4. The microphone of claim 2, wherein a diameter of the substantially flat face is greater than a width of the second end of the housing.

5. The microphone of claim 2, wherein the rotatable positioning member comprises a threaded collar and the second end of the housing comprises complementary threads adapted to receive and removably couple to the threaded collar.

6. The microphone of claim 2, wherein the rotatable positioning member comprises a plurality of ball bearings and an inner body, wherein the plurality of ball bearings and the inner body are adapted to allow the microphone capsule to rotate independently of the connector.

7. The microphone of claim 1, wherein the rotatable positioning member is configured to securely orient the microphone capsule in a plurality of intermediate positions between the first position and the second position.

8. The microphone of claim 1 further comprising a microphone stand integral to the microphone.

9. The microphone of claim 1, wherein the rotatable positioning member is integral to a housing of the microphone.

10. The microphone of claim 1, wherein the rotatable positioning member comprises a ratcheting assembly.

11. The microphone of claim 1, wherein the rotatable positioning member comprises a spring plunger assembly.

12. A microphone comprising:
a housing configured to connect to a cable; and
a rotatable positioning member configured to orient a microphone capsule relative to a surface of an audio output device, wherein the rotatable positioning member is configured to maintain an electrical connection between the housing and the cable based on the rotatable positioning member being rotated from a first position to a second position.

13. The microphone of claim 12, wherein the rotatable positioning member is configured to securely orient the microphone capsule in a plurality of intermediate positions between the first position and the second position.

14. The microphone of claim 12, wherein the housing comprises a first end and a second end opposite the first end, wherein a diameter of the first end of the housing is greater than a width of the second end of the housing.

15. The microphone of claim 12, wherein the rotatable positioning member comprises a ratcheting assembly.

16. The microphone of claim 12, wherein the microphone is further configured to receive a microphone stand clip.

17. The microphone of claim 12, wherein the rotatable positioning member comprises a plurality of ball bearings and an inner body, wherein the plurality of ball bearings and the inner body are adapted to allow the microphone capsule to rotate independently of a connector of the housing.

18. The microphone of claim 12, wherein the rotatable positioning member comprises a threaded collar and a second end of the housing comprises complementary threads adapted to receive and removably couple to the threaded collar.

19. The microphone of claim 12, wherein the rotatable positioning member comprises a spring plunger assembly.

20. A microphone comprising:
a microphone capsule;
a housing configured for connection to a cable;
a rotatable positioning member configured to bias the microphone capsule against a surface of an audio output device; and
a substantially flat face,
wherein the rotatable positioning member and substantially flat face are configured to function in concert to offset a force caused by a tension in the cable based on the rotatable positioning member being rotated from a first position to a second position.
